(19) United States
(12) Patent Application Publication
(10) Pub. No.: US 2017/0155152 A1
(43) Pub. Date: Jun. 1, 2017

(54) BINDER FOR SECONDARY BATTERY HAVING IMPROVED PROPERTIES AND NEGATIVE ELECTRODE FOR SECONDARY BATTERY COMPRISING THE SAME

(71) Applicant: LG CHEM, LTD., Seoul (KR)

(72) Inventors: Jung Woo YOO, Daejeon (KR); Jun Soo PARK, Daejeon (KR); Ji Hee YOON, Daejeon (KR); Je Young KIM, Daejeon (KR)

(73) Assignee: LG CHEM, LTD., Seoul (KR)

(21) Appl. No.: 15/363,767

(22) Filed: Nov. 29, 2016

(30) Foreign Application Priority Data
Nov. 30, 2015 (KR) 10-2015-0168680

(51) Int. Cl. H01M 4/62; H01M 4/587

(52) U.S. Cl. CPC H01M 4/622; H01M 4/625; H01M 4/587; H01M 2004/021

(57) ABSTRACT

The present disclosure relates to a binder for a secondary battery having improved properties and a negative electrode for a secondary battery including the same, and through controlling a weight ratio of styrene-butadiene-based rubber and acryl-based rubber included in the binder for a secondary battery, a negative electrode for a secondary battery having reduced electrode resistance while improving electrode adhesive strength is provided by including the binder having an optimal composition exhibiting most excellent battery properties in identical content.

### FIELD OF THE INVENTION

The present application claims priority to and the benefits of Korean Patent Application No. 10-2015-0168680 filed with the Korean Intellectual Property Office on Nov. 30, 2015, the entire contents of which are incorporated herein by reference.

The present disclosure relates to a binder for a secondary battery having improved properties and a negative electrode for a secondary battery including the same, and in particular, to a binder having an optimal composition ratio by controlling a weight ratio of styrene-butadiene-based rubber and acryl-based rubber, and a secondary battery including the same.

### DESCRIPTION OF THE RELATED ART

With recent increases in technology developments and demands for mobile devices, demands for batteries as an energy source have rapidly increased, and as HEV, PHEV and EV vehicles have received attention as vehicles for the future, researches on batteries capable of responding to various requirements have been widely conducted. Particularly, as a power supply of such devices, researches on lithium secondary batteries having excellent cycle life and cycle properties while having high energy density have been actively conducted.

A lithium secondary battery means a battery including a non-aqueous electrolyte containing lithium ions in an electrode assembly including a positive electrode that includes a positive electrode active material capable of lithium ion intercalation/deintercalation, a negative electrode that includes a negative electrode active material capable of lithium ion intercalation/deintercalation, and a microporous separator provided between the positive electrode and the negative electrode.

Graphite-based materials and Si-based materials are generally used as the negative electrode active material, and although theoretical capacity of a battery varies depending on the types of active materials, a problem of reducing charge and discharge capacity generally occurs as cycles progress.

Such a phenomenon is mostly attributable to separation between electrode active materials or between an electrode active material and a current collector due to changes in the electrode volume occurring as battery charge and discharge progress, and the active material not fulfilling the function.

Accordingly, researches on binders and electrode materials capable of improving structural stability of electrodes by preventing separation between electrode active materials or between an electrode active material and a current collector using strong adhesive strength when preparing electrodes, and promoting enhancement in the battery properties through reducing resistance have been urgently required in the art.

In view of the above, the inventors of the present disclosure have studied a binder for a secondary battery including styrene-butadiene-based rubber and acryl-based rubber, and as a result, have found out a binder having an optimal composition exhibiting most excellent battery properties in identical content through controlling a weight ratio of the components.

### DISCLOSURE OF THE INVENTION

### Technical Problem

The present disclosure is directed to providing a negative electrode for a secondary battery having improved electrode adhesive strength and reduced electrode resistance by including a binder for a secondary battery having an optimal composition ratio exhibiting most excellent battery properties in identical content through controlling a weight ratio of styrene-butadiene-based rubber and acryl-based rubber.

The present disclosure has been made in view of the above, and one embodiment of the present disclosure provides a negative electrode for a secondary battery including a negative electrode active material, a conductor, a binder and a viscosity agent, wherein the binder includes styrene-butadiene-based rubber and acryl-based rubber in a weight ratio of 6:4 to 8:2.

Another embodiment of the present disclosure provides a lithium secondary battery including a positive electrode, a negative electrode, a liquid electrolyte and a separator, wherein the negative electrode is the negative electrode for a secondary battery according to the present disclosure.

Still another embodiment of the present disclosure provides a battery module and a battery pack including the lithium secondary battery.

### Advansageous effects

The present disclosure is capable of reducing electrode resistance while improving electrode adhesive strength by including a binder having an optimal composition ratio exhibiting most excellent battery properties in identical content through controlling a weight ratio of styrene-butadiene-based rubber and acryl-based rubber included in the binder for a secondary battery.

### DESCRIPTION OF DRAWINGS

FIG. 1 is a graph representing electrode adhesive strength of a negative electrode for a secondary battery prepared according to examples and comparative examples of the present disclosure.

FIG. 2 is a graph representing resistance properties of a negative electrode for a secondary battery prepared according to examples and comparative examples of the present disclosure.

FIG. 3 is a graph representing a relation between electrode adhesive strength and resistance properties of a negative electrode for a secondary battery manufactured according to examples and comparative examples of the present disclosure.

### MODE FOR CARRYING OUT THE INVENTION

Hereinafter, the present disclosure will be described in more detail in order to illuminate the present disclosure. Herein, terms or words used in the present specification and the claims are not to be interpreted limitedly to common or dictionary definitions, and shall be interpreted as meanings and concepts corresponding to technological ideas of the present disclosure based on a principle in which the inventors may suitably define the concepts of terms in order to describe the invention in the best possible way.

The present disclosure provides a negative electrode for a secondary battery including a negative electrode active material, a conductor, a binder and a viscosity agent, wherein the binder includes styrene-butadiene-based rubber and acryl-based rubber in a weight ratio of 6:4 to 8:2.

When the styrene-butadiene-based rubber included in the binder of the present disclosure is included in the above-mentioned range, the binder may have a proper glass transition temperature (T_{g}), and cracks on an electrode layer may be prevented by providing proper flexibility to the electrode layer, and problems such as roll contamination do not occur when pressing and rolling the electrode since adhesion on the electrode layer surface increases. Meanwhile, excessively including the styrene-butadiene-based rubber may cause a problem of significantly reducing electrode rigidity.

In addition, including the acryl-based rubber included in the binder of the present disclosure in the above-mentioned range is preferred in terms that charge and discharge properties of an electrochemical device may be further enhanced, and slurry for an electrode having high coating properties may be obtained. Meanwhile, when the acryl-based rubber is excessively included, rigidity of the electrode significantly increases leading to excessive decrease in the adhesive strength, which may cause a problem in the structural stability of the electrode.

As described above, the weight ratio of the styrene-butadiene-based rubber and the acryl-based rubber may be considered as an optimal composition ratio exhibiting most excellent battery properties considering electrode adhesive strength and electrode resistance in identical content, and by including a binder for a secondary battery having the above-mentioned composition ratio, a negative electrode for a secondary battery having reduced electrode resistance while improving electrode adhesive strength may be provided.

Meanwhile, the binder of the present disclosure includes a mixture of the styrene-butadiene-based rubber and the acryl-based rubber, which is different from a binder including a single polymer.

This also applies even when monomer components of the single polymer and monomer components of the mixture of the styrene-butadiene-based rubber and the acryl-based rubber of the present disclosure are the same.

The monomer in the present disclosure is a material that becomes a unit forming a polymer compound or a chemical complex, indicates a starting material in the synthesis of a polymer carried out through a polymerization reaction, and is defined as a concept including a repeating unit derived from a monomer.

When the binder includes a mixture of a polymer (rubber) as described above, effects of readily controlling particle diameters, gel content (90% or higher), glass transition temperatures (Tg) may be additionally obtained.

According to one embodiment of the present disclosure, the styrene-butadiene-based rubber may include a styrene-based monomer and a butadiene-based monomer in a weight ratio of 1:1 to 1.5:1. The styrene-based monomer being included too much may cause a problem of reducing binder flexibility due to too high glass transition temperature, and the butadiene-based monomer being included too much may cause a problem of weakening mechanical properties of the binder due to too low glass transition temperature. Accordingly, styrene-butadiene-based rubber including a styrene-based monomer and a butadiene-based monomer in the above-mentioned weight ratio is mostly preferred.

By including a styrene-based monomer, the styrene-butadiene-based rubber included in the binder of the present disclosure is capable of exhibiting an effect of reducing residual monomers included in the prepared copolymer (rubber) through enhancing polymerization efficiency between each monomer.

Specifically, the styrene-based monomer may be an unsubstituted styrene monomer or a substituted styrene monomer. The substituted styrene monomer may be styrene in which a benzene ring or a vinyl group is substituted with substituents including aliphatic hydrocarbon or heteroatoms. Examples thereof may include one or more selected from the group consisting of styrene, α-methylstyrene, 3-methylstyrene, 4-methylstyrene, 2,4-dimethylstyrene, 2,5-dimethylstyrene, 2-methyl-4-chlorostyrene, 2,4,6-trimethylstyrene, cis-β-methylstyrene, trans-β-methylstyrene, 4-methyl-α-methylstyrene, 4-fluoro-a-methylstyrene, 4-chloro-α-methylstyrene, 4-bromo-α-methylstyrene, 4-t-butylstyrene, 2-fluorostyrene, 3-fluorostyrene, 4-fluorostyrene, 2,4-difluorostyrene, 2,3,4,5,6-pentafluorostyrene, 2-chlorostyrene, 3-chlorostyrene, 4-chlorostyrene, 2,4-dichlorostyrene, 2,6-dichlorostyrene, octachlorostyrene, 2-bromostyrene, 3-bromostyrene, 4-bromostyrene, 2,4-dibromostyrene, α-bromostyrene and β-bromostyrene, but are not limited thereto. More preferably, styrene substituted with C₁₋₄ alkyl or halogen may be used.

As the styrene-based monomer of the present disclosure, one or more selected from the group consisting of styrene, α-methylstyrene, 4-methylstyrene, 4-bromostyrene, 4-chlorostyrene and vinyl toluene may be preferably used, and most preferably, styrene may be used.

In addition, by including a butadiene-based monomer, the styrene-butadiene-based rubber included in the binder of the present disclosure is capable of providing flexibility, tensile strength and elongation to the binder, and accordingly, an effect of obtaining an electrode layer having enhanced adhesion with a current collector may be expected since cracks are difficult to occur on the electrode layer.

As the butadiene-based monomer of the present disclosure, one or more selected from the group consisting of 1,3-butadiene, isoprene, 2,3-dimethyl-1,3-butadiene, 2-ethyl-1,3-butadiene, 1,3-pentadiene and chloroprene may be used, and most preferably, 1,3-butadiene may be used in terms of favorable copolymerizability.

In addition, according to one embodiment of the present disclosure, the acryl-based rubber may include an acrylate-based monomer and an acrylonitrile-based monomer.

By including an acrylate-based monomer, the acryl-based rubber included in the binder of the present disclosure is capable of obtaining an effect exhibiting sufficient dispersibility. Furthermore, in addition to sufficient dispersibility, resistance of an electrochemical device may be reduced since high copolymerizability is obtained, and charge and discharge properties may also be enhanced.

As the acrylate-based monomer of the present disclosure, one or more selected from the group consisting of methacrylic acid esters, acrylic acid esters, unsaturated carboxylic acids, acid anhydrides and esters containing a hydroxyl group.

Specifically, methacrylic acid esters including methyl methacrylate, ethyl methacrylate, propyl methacrylate, butyl methacrylate, hexyl methacrylate, 2-ethylhexyl methacrylate and benzyl methacrylate; acrylic acid esters including methyl acrylate, ethyl acrylate, propyl acrylate, butyl acrylate, hexyl acrylate, 2-ethylhexyl acrylate, cyclohexyl methacrylate, phenyl methacrylate and benzyl methacrylate; unsaturated carboxylic acids including acrylic acid and methacrylic acid; acid anhydrides including maleic anhydride; esters containing a hydroxyl group including 2-hydroxyethyl acrylate, 2-hydroxypropyl acrylate and monoglycerol acrylate; or mixtures thereof.

By including an acrylonitrile-based monomer, the acryl-based rubber included in the binder of the present disclosure is capable of obtaining an effect of reducing resistance through enhancing affinity with a liquid electrolyte.

As the acrylonitrile-based monomer of the present disclosure, one or more selected from the group consisting of acrylonitrile, methacrylonitrile, ethacrylonitrile, phenyl acrylonitrile and α-chloroacrylonitrile may be used. Among these, acrylonitrile and methacrylonitrile are preferred in terms that polymerizability is favorable and raw materials are readily obtained, and particularly, acrylonitrile is mostly preferred.

The negative electrode for a secondary battery according to one embodiment of the present disclosure may include the binder in 1.0% by weight to 2.5% by weight with respect to the total weight of the negative electrode active material, the conductor, the viscosity agent and the binder. When the binder is included in less than 1.0% by weight, the amount of the binder is too small, and electrode adhesive strength that the present disclosure aims for may not be obtained, and when included in greater than 2.5% by weight, content of the negative electrode active material is low leading to decreases in battery capacity and output properties, and a problem of resistance increase may occur.

In addition, according to one embodiment of the present disclosure, the binder of the present disclosure may have a particle diameter (D₅₀) of 150 nm to 400 nm. In the present disclosure, an average particle diameter (D₅₀) may be measured using, for example, a laser diffraction method or a scanning electron microscope (SEM) picture. Generally, the laser diffraction method is capable of measuring a particle diameter from a submicron region to a few mm, and is capable of obtaining results of high reproducibility and high resolution. The average particle diameter (D₅₀) of the binder may be defined as a particle diameter at a 50% base in the particle diameter distribution.

When the binder has a particle diameter (D₅₀) of less than 150 nm, the preparation may not be readily carried out, and there may be a problem of difficult handling due to decreased solid content. On the other hand, when the particle diameter is greater than 400 nm, contact with the negative electrode active material is not sufficient, and lithium ions may not readily migrate, and binder strength may decrease.

According to one embodiment of the present disclosure, the binder of the present disclosure may have a glass transition temperature (T_{g}) of 0° C. to 15° C. When the glass transition temperature is within the above-mentioned range, binding between active materials or binding between an active material and an electrode current collector may be readily achieved, which may improve battery properties.

The viscosity agent according to one embodiment of the present disclosure is a cellulose-based polymer, and one or more selected from the group consisting of carboxymethyl cellulose (CMC), methyl cellulose (MC), hydroxypropyl cellulose (HPC), methyl hydroxypropyl cellulose (MHPC), ethyl hydroxyethyl cellulose (EHEC), methyl ethyl hydroxyethyl cellulose (MEHEC) and cellulose gum may be used, and more preferably, carboxymethyl cellulose (CMC) may be used.

The carboxymethyl cellulose has high viscosity and contributes to adhesive strength while providing excellent coating properties, and therefore, prevents the active material from being eliminated from the current collector, and exhibits excellent cycle properties. In addition, the carboxymethyl cellulose has high solubility, and has favorable properties as a viscosity agent, and therefore, is suitable to be mixed with the binder of the present disclosure and to prepare an aqueous electrode.

More specifically, the carboxymethyl cellulose according to one embodiment of the present disclosure may use those having a molecular weight of 1,000,000 to 4,000,000. When the molecular weight is less than 1,000,000, the negative electrode active material may not be evenly dispersed when forming a network by the viscosity agent due to a decreased attraction force between each polymer forming the network, and may adversely affect cycle life properties due to decreased adhesive strength of the active material. On the other hand, when the molecular weight is greater than 4,000,000, viscosity at the same concentration is too high causing an increase in the slurry viscosity to a degree making coating difficult, and reducing solid in the slurry for preventing this phenomenon may cause another problem of reducing electrode productivity.

The negative electrode for a secondary battery according to one embodiment of the present disclosure may have a loading amount of the negative electrode active material of 250 mg/25 cm² to 400 mg/25 cm². When the loading amount is less than 250 mg/25 cm², the electrode thickness is too small and possibility of causing a problem on adhesive strength and expansion is small, and the loading amount being greater than 400 mg/25 cm² is not preferred since the electrode is too thick and liquid electrolyte wetting into the electrode is not sufficiently accomplished causing concern for rate property decline.

In addition, the negative electrode for a secondary battery according to one embodiment of the present disclosure may have porosity of 22% to 40%. When the porosity is less than 22%, the liquid electrolyte is difficult to penetrate due to few pores, and preferable battery properties may not be obtained. On the other hand, when the porosity is greater than 40%, the amount of the binder required for maintaining proper electrode adhesive strength increases leading to a conductivity decrease, and capacity may be reduced.

According to one embodiment of the present disclosure, the negative electrode for a secondary battery may have electrode adhesive strength of 20 gf/15 mm or greater, however, the upper limit of the adhesive strength is not particularly limited.

Another embodiment of the present disclosure provides a lithium secondary battery including a positive electrode, a negative electrode, a liquid electrolyte and a separator, wherein the negative electrode is the negative electrode for a secondary battery according to the present disclosure.

The lithium secondary battery of the present disclosure may be manufactured according to common methods known in the art. For example, the lithium secondary battery may be manufactured by placing a separator between a positive electrode and a negative electrode, and introducing a liquid electrolyte in which lithium salts are dissolved thereto.

The electrode of the lithium secondary battery may also be prepared using common methods known in the art. For example, the electrode may be prepared by mixing a solvent, and as necessary, a binder, a conductor and a dispersion agent to a positive electrode active material or a negative electrode active material, and stirring the result to prepare slurry, and then applying (coating) the slurry on a current collector made of metal materials, and extruding and then drying the result.

As the positive electrode active material according to one embodiment of the present disclosure, lithium transition metal oxides are preferably used, and examples thereof may include a mixture of one or more selected from the group consisting of LiₓCoO₂ (0.5<x<1.3), LiₓNiO₂ (0.5<x<1.3), LiₓMnO₂ (0.5<x<1.3), LiₓMn₂O₄ (0.5<x<1.3), Liₓ(NiₐCo_{b}Mn_{c})O₂ (0.5<x<1.3, 0<a<1, 0<b<1, 0<c<1, a+b+c=1) , LiₓNi_{1 y}Co_{y}O₂ (0.5<x<1.3, 0<y<1), LixCo_{1-y}Mn_{y}O₂ (0.5<x<1.3, 0≦y<1), LiₓNi_{1-y}Mn_{y}O₂ (0.5<x<1.3, O≦y<1), Liₓ(NiₐCo_{b}Mn_{c})O₄ (0.5<x<1.3, 0<a<2, 0<b<2, 0<c<2, a+b+c=2) , LiₓMn_{2-z}Ni_{z}O₄ (0.5<x<1.3, 0<z<2) , LiₓMn_{2-z}Co_{z} O₄ (0.5<x<1.3, 0<z<2) , LiₓCoPO₄ (0.5<x<1.3) and LiₓFePO₄ (0.5<x<1.3) .

As the negative electrode active material, carbon materials capable of lithium ion intercalation and deintercalation, lithium metal, silicon, tin or the like may be commonly used. Carbon materials are preferably used, and both low crystalline carbon and high crystalline carbon may be used as the carbon material. Low crystalline carbon typically includes soft carbon and hard carbon, and high crystalline carbon typically includes natural graphite, Kish graphite, pyrolytic carbon, mesophase pitch based carbon fiber, mesocarbon microbeads, mesophase pitches and high-temperature baked carbon such as petroleum or coal tar pitch derived cokes.

The current collector made of metal materials is a metal having high conductivity and to which the slurry of the electrode active material may readily adhere, and any material may be used as long as it is not reactive in battery voltage ranges. Non-limiting examples of the positive electrode current collector include foil prepared from aluminum, nickel or combinations thereof, and the like, and non-limiting examples of the negative electrode current collector include foil prepared from copper, gold, nickel or copper alloys, or combinations thereof, and the like.

The conductor is not particularly limited as long as it is generally used in the art, and examples thereof may include artificial graphite, natural graphite, carbon black, acetylene black, Ketjen black, denka black, thermal black, channel black, carbon fiber, metal fiber, aluminum, tin, bismuth, silicon, antimon, nickel, copper, titanium, vanadium, chromium, manganese, iron, cobalt, zinc, molybdenum, tungsten, silver, gold, lanthanum, ruthenium, platinum, iridium, titanium oxide, polyaniline, polythiophene, polyacetylene, polypyrrole, combinations thereof, or the like, and generally, carbon black-based conductors are often used.

The viscosity agent and the binder according to one embodiment of the present disclosure are the same as described above, and the descriptions thereon will not be repeated.

The liquid electrolyte included in the lithium secondary battery according to the present disclosure may be a mixed organic solvents of one or more selected from the group consisting of propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethylmethyl carbonate (EMC), gamma-butyrolactone (GBL), fluoroethylene carbonate (FEC), methyl formate, ethyl formate, propyl formate, methyl acetate, ethyl acetate, propyl acetate, pentyl acetate, methyl propionate, ethyl propionate, propyl propionate and butyl propionate.

In addition, the liquid electrolyte according to the present disclosure may further include a lithium salt, and an anion of the lithium salt may be one or more selected from the group consisting of F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, CF₃)₅PF⁻, (CF₃)₆P⁻, F₃SO₃⁻, CF₃CF₂SO₃⁻, CF₃CF₂SO₂)₂N , (FSO₂)₂N⁻, CF₃CF₂(CF₃)₂CO⁻,(CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻,

The lithium secondary battery according to the present disclosure may be a cylinder-type, a square-type or a pouch-type secondary battery, but is not limited thereto as long as it corresponds to a charge and discharge device.

Still another embodiment of the present disclosure provides a battery module including the lithium secondary battery as a unit cell, and a battery pack including the same.

The battery pack may be used as a power supply of one or more types of medium to large sized devices selected from the group consisting of power tools; electric vehicles including electric vehicles (EV), hybrid electric vehicles (HEV) and plug-in hybrid electric vehicles (PHEV); or systems for power storage.

Hereinafter, examples of the present disclosure will be described in detail so as for those skilled in the art to readily carry out the present disclosure. However, the present disclosure may be implemented in various different forms and is not limited to the examples described herein.

### PREPARATION EXAMPLES 1 to 6

As a binder according to the present disclosure, styrene-butadiene-based rubber and acryl-based rubber were each prepared using an existing emulsion polymerization reaction known in the art, and then mixed so as to have the following content. As the monomer component of the styrene-butadiene-based rubber, styrene and 1,3-butadiene were used identically, and the weight ratio of the components is as follows. Meanwhile, the monomer compound of the acryl-based rubber is as follows.

TABLE 1

| | Styrene- | | Monomer | |
|---|---|---|---|---|
| | Butadiene- | Acryl- | Composition | Monomer |
| | Based | Based | Ratio of | Component |
| | Rubber | Rubber | Styrene- | of Acryl- |
| | Content | Content | Butadiene- | Based |
| | (wt %) | (wt %) | Based Rubber | Rubber |
| Preparation | 72 | 28 | 1:1 | Butyl |
| Example 1 | | | | Acrylate and |
| | | | | Methyl |
| | | | | Methacrylate |
| Preparation | 74.2 | 25.8 | 1.2:1 | Methyl |
| Example 2 | | | | Methacrylate |
| | | | | and |
| | | | | Acrylonitrile |
| Preparation | 30 | 70 | 1:1 | Acrylic Acid |
| Example 3 | | | | |
| Preparation | 36 | 56 | 1:1 | Butyl Acrylate |
| Example 4 | | | | |
| Preparation | 85.9 | 14.1 | 1:1 | Acrylonitrile |
| Example 5 | | | | |
| Preparation | 94 | 6 | 1.5:1 | Butyl Acrylate |
| Example 6 | | | | |

### EXAMPLE 1

1) Preparation of Negative Electrode for Secondary Battery

Negative electrode slurry was prepared by mixing a negative electrode active material (graphite), a conductor (acetylene black), a viscosity agent (CMC, molecular weight 1,300,000) and the binder prepared in Preparation Example 1 in 95.7% by weight, 1% by weight, 1.1% by weight and 2.2% by weight, respectively, in distilled water.

The negative electrode slurry was coated on a copper (Cu) thin film, a negative electrode current collector, having a thickness of 10 μm, and the result was dried to prepare a negative electrode, and the negative electrode was processed using roll press. Porosity of the prepared negative electrode was 28%.

2) Manufacture of Lithium Secondary Battery

Positive electrode slurry was prepared by mixing a positive electrode active material (LiNi_{0.6}Mn_{0.2}Co_{0.2}O₂) , a binder (KF1100) and a conductor (Super-C) in a weight ratio of 93:4:3, respectively, in a solvent (N-methyl-2-pyrrolidone, NMP).

The positive electrode slurry was coated on one surface of an aluminum (Al) thin film, a positive electrode current collector, having a thickness of 20 μm, and the result was dried to prepare a positive electrode, and the positive electrode was processed using roll press.

A liquid electrolyte was prepared by dissolving 1 mol of LiPF₆ in a solvent adding vinylene carbonate to a solvent mixing ethylene carbonate, diethyl carbonate and dimethyl carbonate in a volume ratio of 1:1:2.

After manufacturing a battery using a common method with the positive electrode and the negative electrode together with a separator, the prepared liquid electrolyte was injected thereto to complete the manufacture of a lithium secondary battery.

### EXAMPLE 2

A lithium secondary battery was manufactured in the same manner as in Example 1 except that the binder prepared in Preparation Example 2 was used.

### COMPARATIVE EXAMPLE 1

A lithium secondary battery was manufactured in the same manner as in Example 1 except that the binder prepared in Preparation Example 3 was used.

### COMPARATIVE EXAMPLE 2

A lithium secondary battery was manufactured in the same manner as in Example 1 except that the binder prepared in Preparation Example 4 was used.

### COMPARATIVE EXAMPLE 3

A lithium secondary battery was manufactured in the same manner as in Example 1 except that the binder prepared in Preparation Example 5 was used.

### COMPARATIVE EXAMPLE 4

A lithium secondary battery was manufactured in the same manner as in Example 1 except that the binder prepared in Preparation Example 6 was used.

### TEST EXAMPLE 1

### Evaluation on Electrode Adhesive Strength

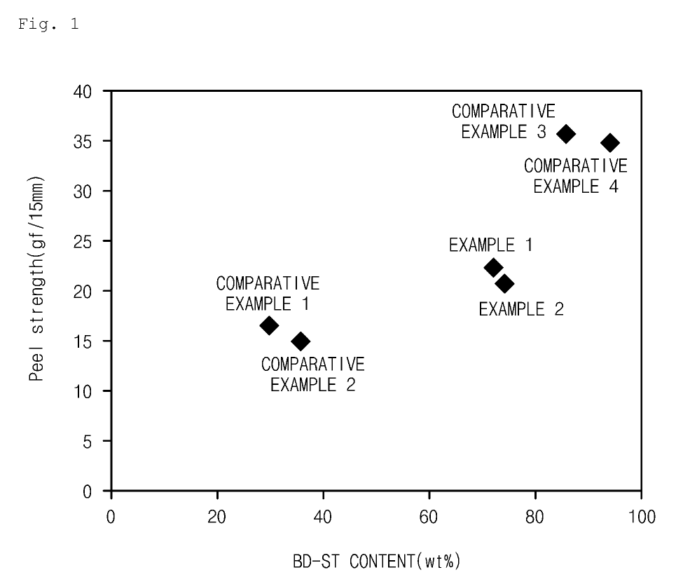

For the negative electrodes for a secondary battery prepared in Examples 1 and 2 and Comparative Examples 1 to 4, electrode adhesive strength was compared by measuring force (gf) required until a tape is detached when pulling the tape at a rate of 10 mm/min using a generally known 180° peel test, and the results are shown in Table 2 and FIG. 1.

### TEST EXAMPLE 2

### Evaluation on Electrode Resistance

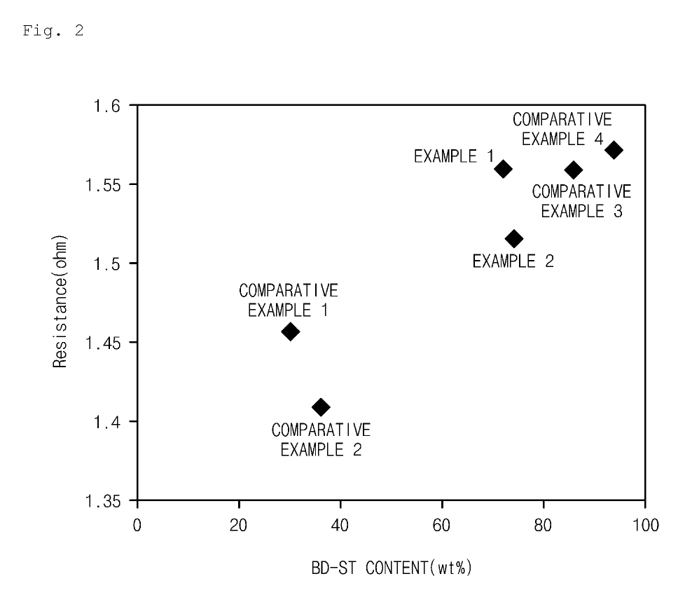

After preparing a single layer pouch cell by assembling the negative electrode for a secondary battery and the positive electrode prepared in Examples 1 and 2 and Comparative Examples 1 to 4, resistance was measured through an electrochemical evaluation flowing current of 2.5 C with respect to capacity for 30 seconds, and the results are shown in Table 2 and FIG. 2.

TABLE 2

| | Electrode Adhesive | |
|---|---|---|
| | Strength (gf/15 mm) | Resistance (ohm) |
| Example 1 | 22.15 | 1.559 |
| Example 2 | 20.83 | 1.515 |
| Comparative | 16.506 | 1.456 |
| Example 1 | | |
| Comparative | 14.95 | 1.409 |
| Example 2 | | |
| Comparative | 35.6 | 1.559 |
| Example 3 | | |
| Comparative | 34.87 | 1.571 |
| Example 4 | | |

As shown in Table 2, was seen that Comparative Examples 3 and 4 including styrene-butadiene-based rubber in excess had excellent electrode adhesive strength, however, resistance properties of the electrode was not favorable, and Comparative Examples 1 and 2 including a small amount of styrene-butadiene-based rubber had excellent resistance properties of the electrode, however, electrode adhesive strength was not favorable.

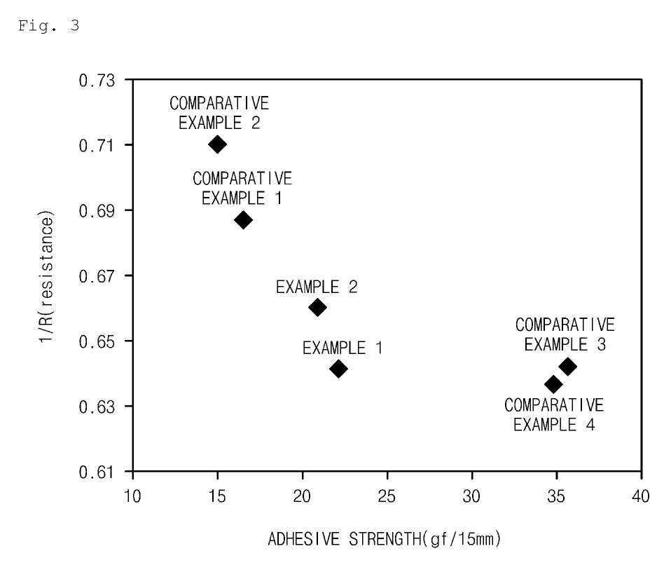

In addition, as shown in FIG. 3, the binder having higher electrode adhesive strength (Comparative Examples 3 and 4) had higher resistance (lower 1/R), which is disadvantageous for output, and on the contrary, when resistance was small (Comparative Examples 1 and 2), electrode adhesive strength was low, and consequently, it can be seen that the choice of a binder exhibiting optimal properties in adhesive strength and resistance is important.

Meanwhile, Examples 1 and 2 including a binder having styrene-butadiene-based rubber and acryl-based rubber in a specific weight ratio exhibited electrode adhesive strength of 20 gf/15 mm or greater, and it was seen that electrode resistance decreased as well while improving electrode adhesive strength.

As a result, an optimal composition ratio of the styrene-butadiene-based rubber and the acryl-based rubber exhibiting most excellent battery properties in identical content was able to be chosen.

Descriptions on the present disclosure provided above are for illustrative purposes only, and it is to be construed that those skilled in the art may readily modify the present disclosure to other specific forms without changing technological ideas or essential characteristics of the present disclosure. Accordingly, embodiments that have been described are for illustrative purposes in all aspects and need to be construed to be non-limitative.

1. A negative electrode for a secondary battery comprising:
a negative electrode active material;
a conductor;
a binder; and
a viscosity agent,
wherein the binder includes styrene-butadiene-based rubber and acryl-based rubber in a weight ratio of 6:4 to 8:2.

2. The negative electrode for a secondary battery of claim 1, wherein the styrene-butadiene-based rubber includes a styrene-based monomer and a butadiene-based monomer in a weight ratio of 1:1 to 1.5:1.

3. The negative electrode for a secondary battery of claim 2, wherein the styrene-based monomer includes one or more selected from the group consisting of styrene, a-methylstyrene, 4-methylstyrene, 4-bromostyrene, 4-chlorostyrene and vinyl toluene.

4. The negative electrode for a secondary battery of claim 2, wherein the butadiene-based monomer includes one or more selected from the group consisting of 1,3-butadiene, isoprene, 2,3-dimethyl-1,3-butadiene, 2-ethyl-1,3-butadiene, 1,3-pentadiene and chloroprene.

5. The negative electrode for a secondary battery of claim 1, wherein the acryl-based rubber includes an acrylate-based monomer and an acrylonitrile-based monomer.

6. The negative electrode for a secondary battery of claim 5, wherein the acrylate-based monomer includes one or more selected from the group consisting of methacrylic acid esters, acrylic acid esters, unsaturated carboxylic acids, acid anhydrides, and esters

7. The negative electrode for a secondary battery of claim 5, wherein the acrylonitrile-based monomer includes one or more selected from the group consisting of acrylonitrile, methacrylonitrile, ethacrylonitrile, phenylacrylonitrile and α-chloroacrylonitrile.

8. The negative electrode for a secondary battery of claim 1, wherein the binder is included in 1.0% by weight to 2.5% by weight with respect to a total weight of the negative electrode active material, the conductor, the viscosity agent and the binder.

9. The negative electrode for a secondary battery of claim 1, wherein the binder has a particle diameter (D₅₀) of 150 nm to 400 nm.

10. The negative electrode for a secondary battery of claim 1, wherein the binder has a glass transition temperature (T_{g}) of 0° C. to 15° C.

11. The negative electrode for a secondary battery of claim 1, wherein the viscosity agent is one or more selected from the group consisting of carboxymethyl cellulose (CMC), methyl cellulose (MC), hydroxypropyl cellulose (HPC), methyl hydroxypropyl cellulose (MHPC), ethyl hydroxyethyl cellulose (EHEC), methyl ethyl hydroxyethyl cellulose (MEHEC) and cellulose gum.

12. The negative electrode for a secondary battery of claim 11, wherein the carboxymethyl cellulose (CMC) has a molecular weight of 1,000,000 to 4,000,000.

13. The negative electrode for a secondary battery of claim 1, wherein the negative electrode active material has a loading amount of 250 mg/25 cm² to 400 mg/25 cm².

14. The negative electrode for a secondary battery of claim 1, wherein the negative electrode for a secondary battery has porosity of 22% to 40%.

15. The negative electrode for a secondary battery of claim 1, wherein the negative electrode for a secondary battery has electrode adhesive strength of 20 gf/15 mm or greater.

16. A lithium secondary battery comprising:
a positive electrode;
a negative electrode;
a liquid electrolyte; and
a separator, wherein the negative electrode is the negative electrode for a secondary battery of claim 1.

17. A battery module comprising the lithium secondary battery of claim 16 as a unit cell.

18. A battery pack comprising the battery module of claim 17.

19. The battery pack of claim 18, which is used as a power supply of one or more types of medium to large sized devices selected from the group consisting of power tools, electric vehicles, hybrid electric vehicles, plug-in hybrid electric vehicles and systems for power storage.
